(19) United States
(12) Patent Application Publication
(10) Pub. No.: US 2006/0278714 A1
(43) Pub. Date: Dec. 14, 2006

(54) Portable communication apparatus having optics character recognition function

(76) Inventors: David Ho, Taipei (TW); Jia Li, Taipei (TW); Tony Tsai, Taipei (TW)

Correspondence Address: KIRTON AND MCCONKIE, 60 EAST SOUTH TEMPLE,, SUITE 1800, SALT LAKE CITY, UT, 84111, US

(21) Appl. No.: 11/452,011

(22) Filed: Jun. 13, 2006

(30) Foreign Application Priority Data
Jun. 14, 2005 (TW) 094119732

(51) Int. Cl. G06K 7/10

(52) U.S. Cl. 235/472.01; 235/472.02

(57) ABSTRACT

This invention discloses a portable communication apparatus having an optical character recognition (OCR) function. The apparatus at least contains an optical input unit, a processing unit and an edition unit. After the optical input unit obtains the image information which is further transformed by the processing unit to letters which can be processed by the portable communication apparatus, the edition unit then can edit and/or store the letters into the portable communication apparatus to finish the OCR function.

### FIELD OF THE INVENTION

The present invention relates to a communication apparatus, and more particularly to a portable communication apparatus.

### BACKGROUND OF THE INVENTION

With the increasing improvement of communication techniques, the portable communication devices such as mobile phones are more and more popularized. Conventionally, it always adopts the pad input or handwriting input for inputting the information to the portable communication devices. With reference to FIG. 1, which schematically shows the construction of a conventional mobile phone according to the prior art, the conventional mobile phone 1 is constructed by a base portion 11, a display 12 for showing all the function options and a pad 13 serving as the input device thereof.

Moreover, please refer to FIG. 2, which is a flowchart illustrating the steps of a conventional input method adopted in the mobile phone according to the prior art. First, a desired function option of the mobile phone is selected, so as to enter into the phone directory constructed therein, as shown in the steps S21 and S22, respectively. For editing the phone directory, the desired information is input and/or modified by means of pad input or handwriting input, as shown in the step S23. After the information to be input or stored in the mobile phone is recognized, the edition procedure is completed and then the user may escape from the function option regarding the phone directory, as shown in the respective steps S24 and S25. No matter what kinds of input codes are adopted, it is believed inconvenient for the user to edit the information by means of pad input or handwriting input with the pad having a limited area, which makes such conventional mobile phones relatively disadvantageous.

For overcoming the mentioned drawbacks of the prior art, a novel portable communication apparatus is provided. The provided portable communication apparatus is provided with an optical character recognition function, in which an optical input unit is configured for obtaining the image information. The obtained image information is transformed into text information that is recognizable for the portable communication apparatus, so as to be processed and stored therein. Moreover, the optical input unit also provides a quick operation for information input, whereby it would be more flexible and convenient to obtain any desired information for being further processed. Accordingly, the image information obtained by the optical input unit could be edited by the edition unit or editor configured in the portable communication apparatus. In comparison with the conventional portable communication apparatus whose optical input unit functions only for taking a shot, the present portable communication apparatus is provided with an enhanced function, where an optical character recognition function is achieved thereby.

### SUMMARY OF THE INVENTION

It is an aspect of the present invention to provide a portable communication apparatus with an enhanced function.

In accordance with the mentioned aspect, a portable communication apparatus having a function of optical character recognition is provided. The provided portable communication apparatus includes an optical input unit configured for capturing an image information of texts or characters, an optical character recognition unit connecting to the optical input unit for recognizing the texts or characters by analyzing the image information, a transforming unit connecting to the optical character recognition unit, and an editing unit connecting to the transforming unit.

In accordance with the mentioned aspect, when the optical character recognition unit recognizes the texts or characters, the transforming unit would transform the image information into a machine-editable text information or an encoding scheme to be edited by the editing unit.

Preferably, the portable communication apparatus further includes a display unit.

Preferably, the portable communication apparatus further includes an operation interface.

Preferably, the optical input unit is a camera.

Preferably, the image information is an image information of printed texts or characters, and the printed texts or characters are selected from the content of a book, the content of a newspaper, and the printed content of a manuscript or a typescript.

Preferably, the printed texts or characters constitute a table.

Preferably, the portable communication apparatus further includes a storage unit for storing the text information or the encoding scheme.

Preferably, the encoding scheme represents the texts or characters in ASCII (American Standard Code for Information Interchange).

Preferably, the encoding scheme represents the texts or characters in Unicode.

The foregoing and other features and advantages of the present invention will be more clearly understood through the following descriptions with reference to the drawings, wherein:

### BRIEF DESCRIPTION OF THE DRAWINGS

FIG. 1 is a diagram schematically showing the construction of a conventional mobile phone according to the prior art;

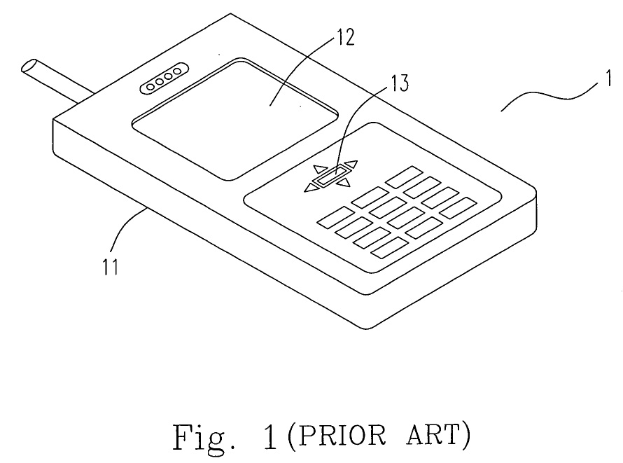

FIG. 2 is a flowchart illustrating the steps of a conventional input method adopted in the mobile phone according to the prior art;

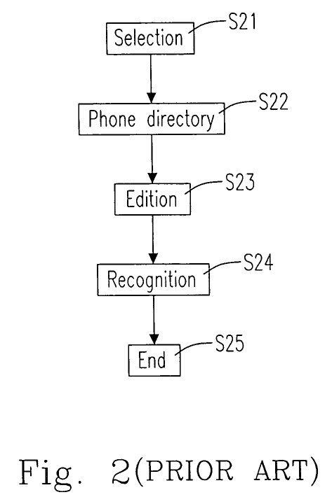

FIG. 3 is a stereo diagram for illustrating the appearance of a portable communication apparatus according to a preferred embodiment of the present invention;

FIG. 4 is a schematic diagram for illustrating the operation interface of a portable communication apparatus according to a preferred embodiment of the present invention;

FIG. 5 is a schematic diagram for illustrating the interior construction of a portable communication apparatus according to a preferred embodiment of the present invention;

FIG. 6 is a flowchart illustrating the steps of an input method adopted in the portable communication apparatus according to a preferred embodiment of the present invention; and

FIG. 7 is a flowchart illustrating the steps of an input method adopted in the portable communication apparatus according to a further preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

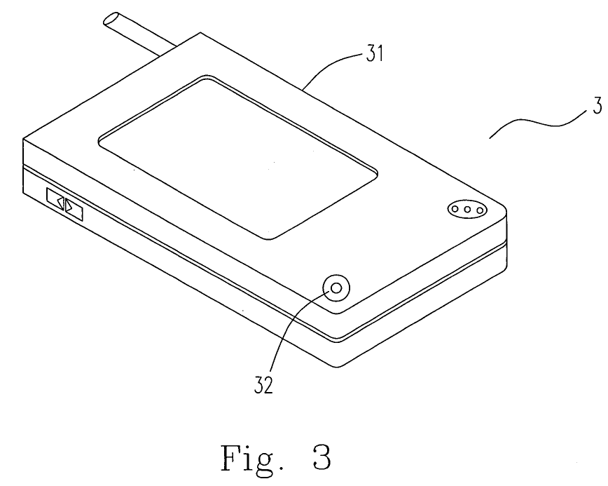

With reference to FIG. 3, the appearance of a portable communication apparatus according to a preferred embodiment of the present invention is schematically illustrated. The portable communication apparatus 3 includes a communication device 31 and an optical input unit 32. In this embodiment, the optical input unit 32 is a camera for capturing the image information, e.g. an image information of printed texts or characters regarding the content of a book, a newspaper, a manuscript or typescript and a constituted table.

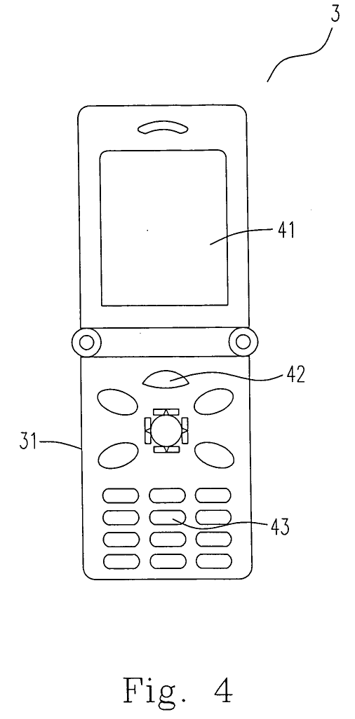

Please refer to FIG. 4, which is a schematic diagram for illustrating the operation interface of a portable communication apparatus according to a preferred embodiment of the present invention. In addition to the communication device 31, the portable communication apparatus 4 further includes a display unit 41 for showing all of the function options, a hot key 42 where the function regarding the optical input is preset therein and an operation interface 43 for the input operation and selection operation. Through the configuration of the hot key 42, it is not necessary to start up the optical input function through selecting from the whole function options, which is advantageous in saving the operation time and efforts.

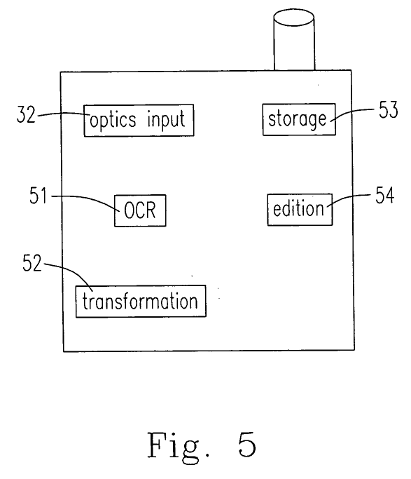

Please refer to FIG. 5, which is a schematic diagram for illustrating the interior construction of a portable communication apparatus according to a preferred embodiment of the present invention. In addition to the optical input unit 32, the portable communication apparatus further includes an optical character recognition (OCR) unit 51, a processing unit 52, a storage unit 53 and an editing unit 54 configured therein. The image information obtained by the optical input unit 32 is recognized by the OCR unit 51, and then is transformed into a machine-editable text information or an encoding scheme by the processing unit 52, which could be successfully recognized by the portable communication apparatus. The recognized text information as well as the machine-editable text information or the encoding scheme are stored in the storage unit 53, which could be further edited through the editing unit 54.

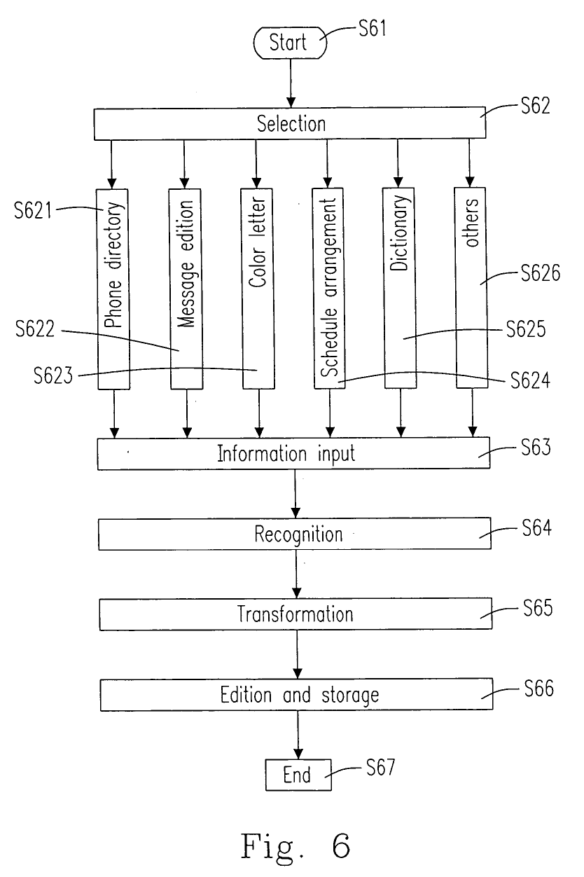

Furthermore, please refer to FIG. 6, which is a flowchart illustrating the steps of an input method adopted in the portable communication apparatus according to a preferred embodiment of the present invention. The method is started with the selection of an edition function, as shown in the step S61. All of the function options of the portable communication apparatus are shown to the user through the display unit and thereamong the edition function is selected, as shown in the step S62. Depending on an actual desire, the user decides to enter the functions regarding the phone directory, the message edition, the color letter edition, the schedule arrangement, the dictionary or others, as shown in the steps S621˜S626, respectively. Afterward, the desired image information of printed texts or characters is obtained by the optical input unit, as shown in the step S63. The obtained image information is recognized by the OCR unit configured in the portable communication apparatus, as shown in the step S64. After the recognition, the image information is transformed into a machine-editable text information or an encoding scheme, and then is transmitted to the editor configured in the portable communication apparatus, as shown in the step S65. The text information is edited through the editor, and is further stored in the storage unit, as shown in the step S66. The input method adopted in the portable communication apparatus according to a preferred embodiment of the present invention is finished, as shown in the step S67.

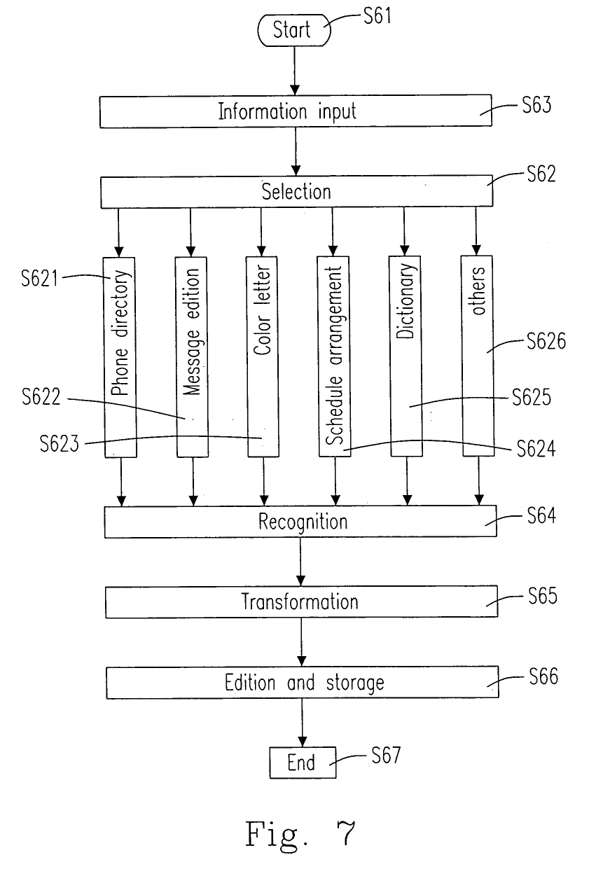

FIG. 7 is a flowchart illustrating the steps of an input method adopted in the portable communication apparatus according to a further preferred embodiment of the present invention. Alternatively, the method is started with the image information input by the optical input unit, as shown in the step S61. In more specifics, the desired image information of printed texts or characters is obtained by the optical input unit, as shown in the step S63. Afterward, the edition function is selected among the whole function options of the portable communication apparatus shown on the display, as shown in the step S62. Depending on an actual desire, the user decides to enter the functions regarding the phone directory, the message edition, the color letter edition, the schedule arrangement, the dictionary or others, as shown in the steps S621˜S626, respectively. Similarly, the obtained image information is recognized by the OCR unit configured in the portable communication apparatus, as shown in the step S64. After the recognition, the image information is transformed into a machine-editable text information or an encoding scheme, and then is transmitted to the editor configured in the portable communication apparatus, as shown in the step S65. The text information is edited through the editor, and is further stored in the storage unit, as shown in the step S66. The input method adopted in the portable communication apparatus according to a preferred embodiment of the present invention is finished, as shown in the step S67.

Through the provided portable communication apparatus and the input method according to the present invention, it is more flexible and convenient to obtain any desired information for being further processed, and the obtained image information could be edited by the edition unit or editor configured in the portable communication apparatus. In comparison with the conventional portable communication apparatus whose optical input unit functions only for taking a shot or picture, the present portable communication apparatus is provided with an enhanced function, where an optical character recognition function is achieved thereby. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A portable communication apparatus having a function of optical character recognition, comprising:
an optical input unit configured for capturing an image information of texts or characters;
an optical character recognition unit connecting to said optical input unit for recognizing said texts or characters by analyzing said image information;
a transforming unit connecting to said optical character recognition unit, wherein when said optical character recognition unit recognizes the texts or characters, said transforming unit transforms said image information into a machine-editable text information or an encoding scheme; and
an editing unit connecting to said transforming unit for editing said machine-editable text information or said encoding scheme.

2. The portable communication apparatus according to claim 1, further comprising a display unit.

3. The portable communication apparatus according to claim 1, further comprising an operation interface.

4. The portable communication apparatus according to claim 1, wherein said optical input unit is a camera.

5. The portable communication apparatus according to claim 1, wherein said image information is an image information of printed texts or characters.

6. The portable communication apparatus according to claim 5, wherein said printed texts or characters are the content of a book.

7. The portable communication apparatus according to claim 5, wherein said printed texts or characters are the content of a newspaper.

8. The portable communication apparatus according to claim 5, wherein said printed texts or characters are the printed content of a manuscript or a typescript.

9. The portable communication apparatus according to claim 5, wherein said printed texts or characters constitute a table.

10. The portable communication apparatus according to claim 1, further comprising a storage unit for storing said text information or said encoding scheme.

11. The portable communication apparatus according to claim 1, wherein said encoding scheme represents the texts or characters in ASCII (American Standard Code for Information Interchange).

12. The portable communication apparatus according to claim 1, wherein said encoding scheme represents the texts or characters in Unicode.
